(19) United States
(12) Patent Application Publication
(10) Pub. No.: US 2005/0157068 A1
(43) Pub. Date: Jul. 21, 2005

(54) Inkjet print head

(76) Inventors: Chee-Shuen Lee, Jhubei City (TW); Jui-Hua Hu, Taiping City (TW); Jia-Lin Chen, Hsinchu City (TW)

Correspondence Address: J C PATENTS, INC., 4 VENTURE, SUITE 250, IRVINE, CA, 92618, US

(21) Appl. No.: 10/823,451

(22) Filed: Apr. 12, 2004

(30) Foreign Application Priority Data
Jan. 20, 2004 (TW) 93201151

(51) Int. Cl. B41J 2/135

(52) U.S. Cl. 347/44

(57) ABSTRACT

An inkjet print head comprising an ink chip, at least a heater, a chamber layer and a nozzle plate is provided. The heater and the chamber layer are formed on the surface of the ink chip. The chamber layer has at least an ink channel and at least an ink chamber. The ink chamber exposes the heater and connects to a reservoir through the ink channel. The ink chamber has a plurality of chamber walls. At least one of the chamber walls has a first area and a second area. The first area corresponds to the heater. The first area and the second area have a distance offset for forming at least a collecting room. The nozzle plate is positioned over the chamber layer. The nozzle plate has at least a nozzle positioned above the heater. By forming the collecting room, air bubbles and/or impurities within the ink can be collected after an ink-jetting operation.

### CROSS-REFERENCE TO RELATED APPLICATION

This application claims the priority benefit of Taiwan application serial no. 93201151, filed on Jan. 20, 2004.

### BACKGROUND OF THE INVENTION

1. Field of the Invention

The present invention relates to an inkjet print head. More particularly, the present invention relates to a thermal bubble ink jet print head capable of collecting, holding and/or isolating any air bubbles and/or impurities within the ink or generated after an ink-jetting operation.

2. Description of Related Art

With the rapid development in the electronic industry, many high-tech products are produced in recent years. In particular, there is a major revolution in the design of printers, from the pin-activated and monochromatic laser printing to color inkjet and color laser printing. The two major methods used by a conventional inkjet printer for producing ink jets are the piezoelectric and thermal bubble techniques. One major aspect of the techniques is to target jets of ink onto a recording medium such as a paper so that words, images, or patterns are formed on the surface of the recording medium. In the piezoelectric jetting technique, the actuator is a piezoelectric material layer. When a voltage is applied to the piezoelectric material, the piezoelectric layer deforms to pressurize the ink within an ink chamber so that a jet of ink is forced out from the ink chamber via an ink nozzle. In the thermal bubble jetting technique, a small quantity of ink is rapidly vaporized by a heater (resistor) to generate a sudden increase of pressure in the ink so that a droplet of ink is squeezed out from an ink chamber via an ink nozzle.

FIG. 1 is a perspective view of a conventional inkjet print head. FIG. 2 is a top view of the inkjet print head in FIG. 1. As shown in FIGS. 1 and 2, a conventional inkjet print head 100 mainly comprises an ink chip 110, a plurality of heaters 120 (only one in shown), a chamber layer (or dry film layer) 130 and a nozzle plate 140. The ink chip 110 has a surface 112 and an ink slot 114. The ink slot 114 has an elongated shape (but can also be in other shapes such as an elliptical or circular shape) and is formed through the entire ink chip 110. Both the heaters 120 and the chamber layer 130 are formed on the surface 112 of the ink chip 110. The chamber layer 130 has a plurality of ink channels 132 (only one is shown) and a plurality of ink chambers 134 (only one is shown). The ink chamber 134 exposes the heaters 120. Furthermore, the ink chamber 134 is connected to the ink slot 114 through the ink channel 132. The nozzle plate 140 is positioned above the chamber layer 130. The nozzle plate 140 has a plurality of nozzles 142 (only one is shown). The nozzles 142 are formed through the nozzle plate 140 and are positioned above the heaters 120 respectively.

To perform a printing operation with the inkjet print head shown in FIGS. 1 and 2, ink has to flow into the ink chamber 134 from the ink slot 114 of the ink chip 110 via the ink channel 132. Upon energization of the heater 120, a thin layer of the adjacent ink is superheated, causing explosive vaporization and, consequently, causing a droplet of ink to be ejected through the nozzle 142.

FIG. 3 is a perspective view showing the ink cartridge of a conventional inkjet printer. As shown in FIG. 3, the ink cartridge 10 comprises an ink cartridge body 12 (acting as an ink reservoir) for holding ink. One end of the ink cartridge body 12 has a snout 14. An inkjet print head 100 is positioned on the snout 14. The nozzle plate 140 of the inkjet print head 100 is positioned on the upper surface 24 of the snout 14 so that the nozzles 142 are exposed. A thin circuit 20 is attached to the cartridge body 12 of the ink cartridge 10, partly on one side 22 of the cartridge 10 adjacent the snout 14. The circuit 20 extends from the side 22 and bends substantially in a perpendicular direction to extend across most of the upper surface 24 of the snout 14. The circuit 20 carries conductive traces. The traces connect at one end to contact pads (not shown) in the print head 100. The other ends of the traces terminate in contact pads 26 on the circuit, which pads mate with corresponding pads on a carriage (not shown). The circuit 20 carries control signals from a microprocessor-based printer controller to the individual components in the print head 100 (primarily the heater or heat transducers) that produce the ink drop ejection through the nozzles 142 of the nozzle plate 140. A detailed description may be referred to U.S. Pat. No. 6,447,104.

As shown in FIG. 2, the conventional ink chamber 134 basically comprises three chamber walls 136 that encompass the heaters 120. In general, air bubbles and impurities may be collected at the corner regions of the ink chamber 134 after a firing of an ink jet. When air bubbles and impurities accumulate, the corners of the heater 120 may be covered by the bubbles and/or impurities. The ink for replenishing the ink chamber 134 may be therefore prevented from filling up the heating area of the heater 120. Therefore, the heater 120 will be heating nothing except air and/or impurities at the corner regions when the heater 120 is activated. Empty heating in part of the heater 120 not only shortens the life of the heater 120 but also reduce overall stability of the ink-jetting operation.

### SUMMARY OF THE INVENTION

Accordingly, the present invention is related to an inkjet print head capable of collecting, holding and/or isolating air bubbles and/or impurities left after an ink-jetting operation for increasing jetting stability and extending the life of print head.

According to an embodiment of the present invention, the inkjet print head is capable of increasing refilling frequency and drop volume during a printing operation.

According to an embodiment of the invention, the inkjet print head comprises an ink chip, at least a heater, a chamber layer and a nozzle plate. The ink chip has a surface and at least an ink slot. The ink slot is formed through the ink chip. The heater and the chamber layer are formed on the surface of the ink chip. The chamber layer has at least a first ink channel and at least an ink chamber. The ink chamber exposes the heater and connects to the ink slot of the ink chip by the first ink channel. The ink slot provides a second ink flooding channel to an ink reservoir. The ink chamber has a plurality of chamber walls. At least one of the chamber walls has a first area and a second area. The first area corresponds to the heater (partially or completely). There is a distance offset between the first area and the second area. The nozzle plate is positioned over the chamber layer. The nozzle plate has at least a nozzle that is formed through the nozzle plate and above the corresponding heater.

According to an alternative embodiment of the present invention, the inkjet print head comprises an ink chip, at least a heater, a chamber layer and a nozzle plate. The ink chip has a surface and at least an ink slot. The ink slot is formed through the ink chip. The heater and the chamber layer are formed on the surface of the ink chip. The chamber layer has at least a first ink channel and at least an ink chamber. The ink chamber exposes the heater and connects to the ink slot of the ink chip by the first ink channel. The ink chamber has a plurality of chamber walls. At least one of the chamber walls has a recess area forming a collecting room. The nozzle plate is positioned over the chamber layer. The nozzle plate has at least a nozzle that is formed through the nozzle plate and above the corresponding heater.

According to yet another alternative embodiment of the present invention, the inkjet print head comprises an ink chip, at least a heater and a nozzle plate. The ink chip has a surface and at least an ink slot. The ink slot passes through the ink chip. The heater and the nozzle plate are positioned on the surface of the ink chip. The nozzle plate has at least a first ink channel, at least an ink chamber and at least a nozzle. The ink chamber exposes the heater and connects to the ink slot of the ink chip by the first ink channel. The ink chamber has a plurality of chamber walls. At least one of the chamber walls has a first area and a second area. The first area corresponds to the heater (partially or completely). There is a distance offset between the first area and the second area. The nozzle plate has at least a nozzle that is formed through the nozzle plate and above the corresponding heater. The nozzle is positioned directly above the heater and linked to the ink chamber.

According to yet another alternative of the present invention, the inkjet print head comprises an ink chip, at least a heater and a nozzle plate. The ink chip has a surface and at least an ink slot. The ink slot is formed through the ink chip. The nozzle plate has at least a first ink channel, at least an ink chamber and at least a nozzle. The ink chamber exposes the heater and connects to the ink slot of the ink chip by the first ink channel. The ink chamber has a plurality of chamber walls. At least one of the chamber walls has a recess area forming a collecting room. The nozzle is associated with one heater and is located near the heater in a nozzle plate.

In one embodiment of the present invention, the distance from the first area of the chamber wall to the corresponding heater is about 1 μm to about 38 μm.

In one embodiment of the present invention, the nozzles are not positioned above the collecting rooms. The nozzles are above the corresponding heaters respectively and each nozzle is one-to-one corresponding with a single heater. In other words, the nozzle is not over the area of collecting rooms of the chamber wall.

In one embodiment of the present invention, the chamber layer (or the nozzle plate) further comprises a pair of first ink-channeling surfaces. One first ink-channeling surface is formed on the first side of the first ink channel, and the other first ink-channeling surface is formed on the other side of the first ink channel. The surface of the ink chip further includes an island (or a block). The island has a pair of second ink-channeling surfaces. The island is formed between the first ink channel and the ink slot. The first ink-channeling surfaces and the second ink-channeling surfaces together form a pair of second ink channels joined to the first ink channel. The first ink-channeling surfaces and their corresponding second ink-channeling surfaces can be parallel to each other. By placing an island on the ink chip, two separate second ink channels merge into the first ink channel. Hence, ink refilling frequency and jetting stability of the ink jet printer during printing operation is improved.

In the embodiment of the present invention, if the first ink channel, the ink chamber and the nozzles are fabricated together on a nozzle plate, the nozzle plate further comprises a projection protruding from the bottom surface of the nozzle plate. The projection is located between the first ink channel and the ink slot, and can be have a distance from the surface of the ink chip. In addition, the projection on the nozzle plate has a pair of second ink-channeling surfaces. The first ink-channeling surfaces formed on the sides of the first ink channel and the second ink-channeling surfaces together form a pair of second ink channels that join to the first ink channel, which can improve the ink refilling frequency and jetting stability of the ink jet printer during operation.

In one embodiment of the present invention, the chamber walls of the ink chamber within the inkjet print head has a distance offset between two areas formed on the chamber wall so that at least one collecting room is formed. Consequently, any air bubbles and/or impurities generated after an ink-jetting operation is collected inside the collecting room. With this design, the inkjet print head can have a higher jetting stability and a longer life. Furthermore, by forming an island in front of or within the ink channel that leads to the ink chamber, two ink channels capable of increasing the ink refilling frequency and ink drop volume of the ink jet printer are formed.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a conventional inkjet print head.

FIG. 2 is a top view of the inkjet print head in FIG. 1.

FIG. 3 is a perspective view showing the ink cartridge of a conventional inkjet printer.

FIG. 4 is a perspective view of an inkjet print head according to one embodiment of the present invention.

FIG. 5 is a top view of the inkjet print head in FIG. 4.

FIG. 6 is a top view of an inkjet print head according to another embodiment of the present invention.

FIGS. 7 and 8 are top views of an inkjet print head according to another two embodiments of the present invention.

FIG. 9 is a perspective view of an inkjet print head according to another embodiment of the present invention.

FIG. 10 is a top view of the inkjet print head in FIG. 9.

FIG. 11 is a perspective view of an inkjet print head according to yet another embodiment of the present invention.

FIG. 12 is a sectional view of an inject print head according to another embodiment of the present invention applied on the edge feeding chip.

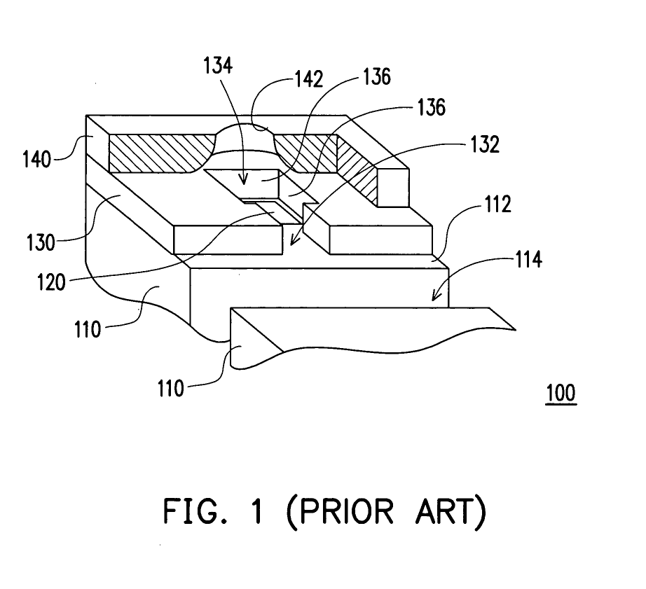

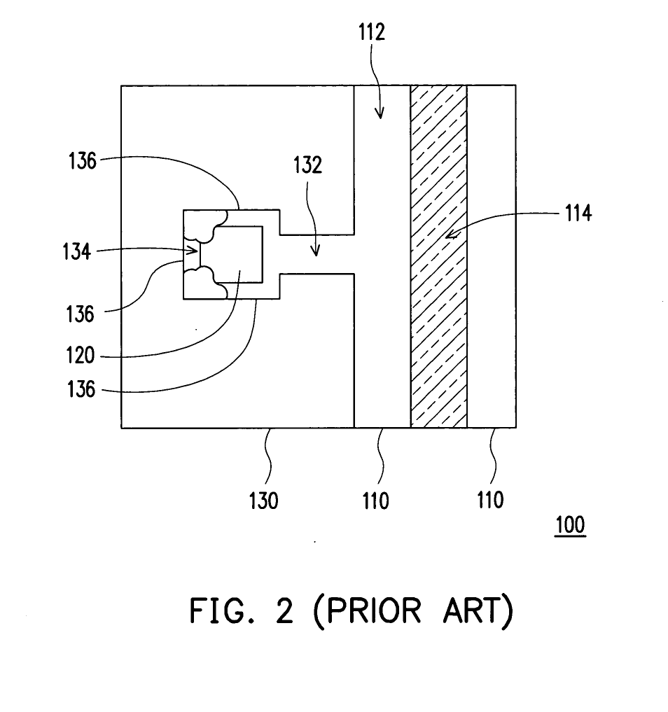

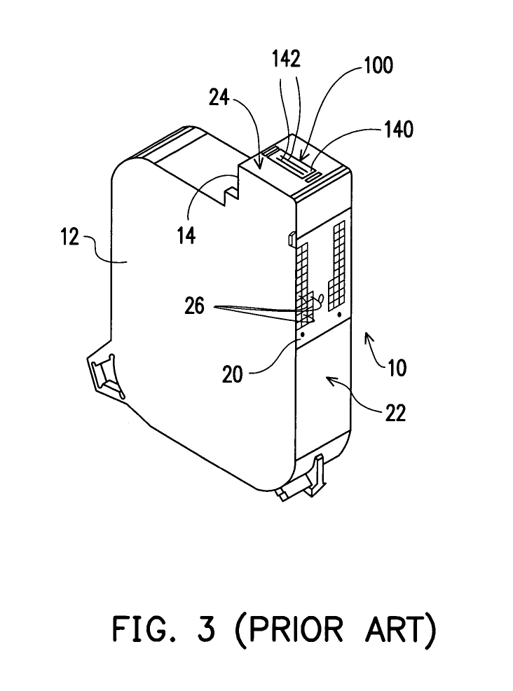

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

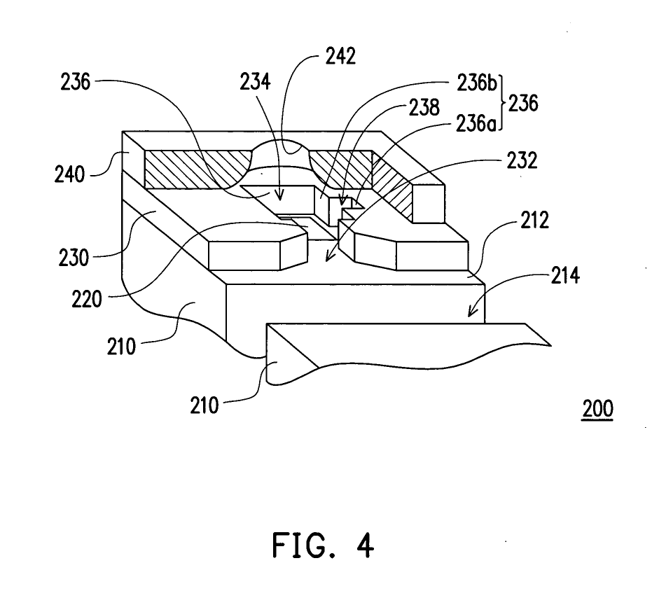

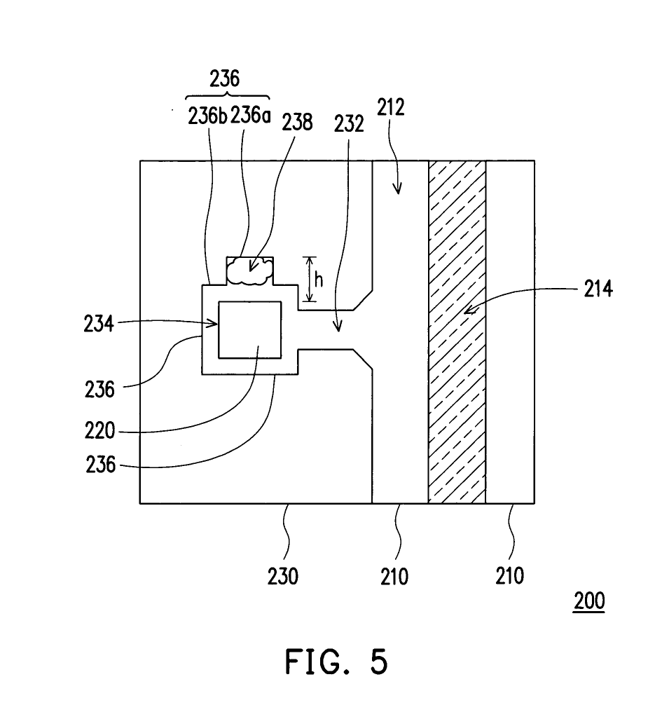

FIG. 4 is a perspective view of an inkjet print head according to one embodiment of the present invention. FIG. 5 is a top view of the inkjet print head in FIG. 4. As shown in FIGS. 4 and 5, the inkjet print head 200 comprises an ink chip 210, a plurality of heaters 220 (only one is shown), a chamber layer 230 and a nozzle plate 240. For the sake of simplification, the nozzle plate 240 in FIG. 4 is omitted in FIG. 5. The ink chip 210 has a surface 212 and at least an ink slot 214. The ink slot 214 has an elongated shape (other suitable shape may be used, for example, an elliptical or a circular shape) and is formed through the ink chip 210. The heaters 220 and the chamber layer 230 are formed on the surface 212 of the ink chip 210.

The chamber layer 230 has a plurality of first ink channels 232 (only one is shown) and a plurality of ink chambers 234 (only one is shown). The ink chamber 234 exposes the heater 220 and is connected to the ink slot 214 by the first ink channel 232. The ink chamber 234 has a plurality of chamber walls 236. At least one of the chamber walls 236 has a first area 236a and a second area 236b. The first area 236a corresponds to the heater 220. The first area 236a and the second area 236b separate from each other by an offset distance. In this embodiment, the first area 236a is formed further away from the heater 220 than the second area 236b so that the chamber wall 236 caves in to form a collecting room 238. It should be noted that the aforementioned correspondence between the first area 236a and the heater 220 and similar description in subsequent embodiments means that the first area 236a may completely or partially correspond to the heater 220.

The nozzle plate 240 is positioned over the chamber layer 230. The nozzle plate 240 has a plurality of nozzles 242 (only one is shown). The nozzle 242 is formed through the nozzle plate 240 and is located above the heater 220 instead of above the collecting room 238. In this embodiment, each nozzle 242 corresponds to a single heater 220.

To perform a printing operation with the inkjet print head shown in FIGS. 4 and 5, ink flows into the ink chamber 234 from the ink slot 214 of the ink chip 210 via the first ink channel 232. Upon energization of the heater 220, a thin layer of the adjacent ink is superheated, causing explosive vaporization and, consequently, causing a droplet of ink to be ejected through the nozzle 242. It should be noted that because one of the chamber walls 236 of the ink chamber 234 caves in to form the collecting room 238, any bubbles and/or impurities within ink or generated after an ink-jetting operation are collected inside the collecting room 238. This prevents the air bubbles and/or impurities from covering a portion of the heater 220 so that replenishing ink can easily rush in to fill the space above the heater 220. Since empty burning of part of the heater 220 is prevented, the print head 200 can eject an ink jet with a higher ink-jetting stability and a print head with longer life.

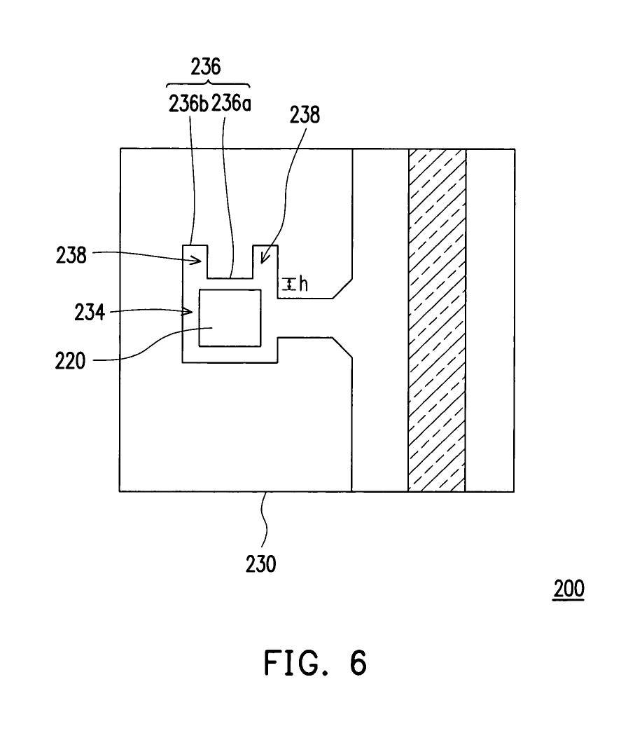

FIG. 6 is a top view of an inkjet print head according to another preferred embodiment of the present invention. The inkjet print head 200 has an almost identical structure as the aforementioned embodiment. One major difference is that the first area 236a is closer to the heater 220 than the second area 236b so that the chamber wall 236 caves in to form two collecting rooms 238.

As shown in FIGS. 5 and 6, one major aspect of the inkjet print head 200 according to an embodiment of the present invention is to partition the chamber wall 236 of the ink chamber 234 into a first area 236a and a second area 236b with an offset distance between the two areas. Therefore, one or more collecting rooms 238 for trapping air bubbles and/or impurities within the ink after an ink-jetting operation are provided. The distance h from the first area 236a of the chamber wall 236 to the heater 220 is between about 1 μm to about 38 μm, for example. However, the distance h is preferably between about 1 μm to about 25 μm and more preferably if the distance h is between about 1 μm to about 10 μm.

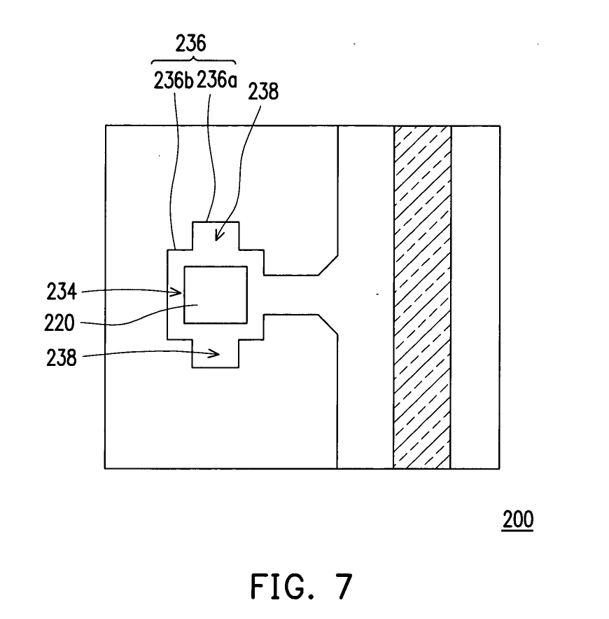

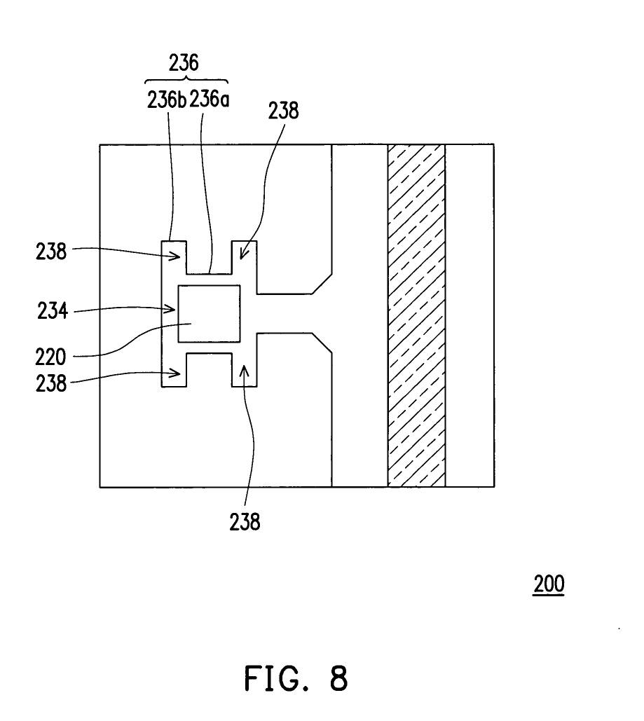

FIGS. 7 and 8 are top views of an inkjet print head according to another two preferred embodiments of the present invention. In the aforementioned embodiments, one or more collecting rooms 238 are formed on one of the chamber walls 236 of the ink chamber 234. However, any person skilled in the art may know that one or more collecting rooms 238 may form on some or all of the chamber walls 236 (two chamber walls have collecting rooms in FIGS. 7 & 8 for example) to increase the capacity of collecting (trapping) air bubbles and/or impurities during operation.

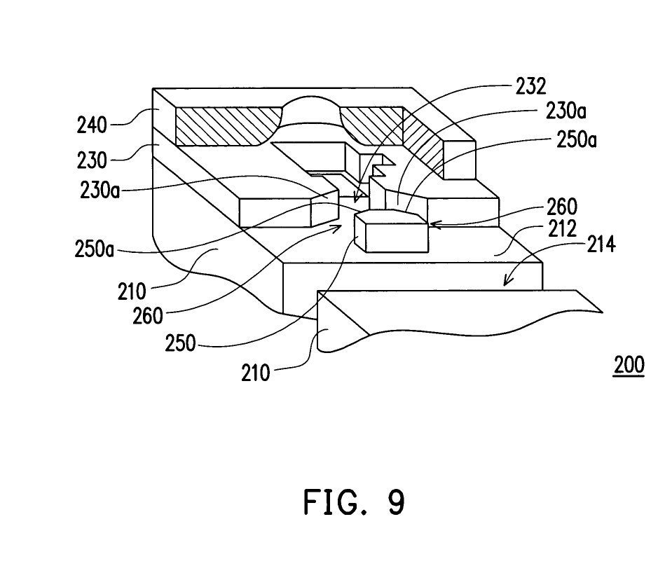

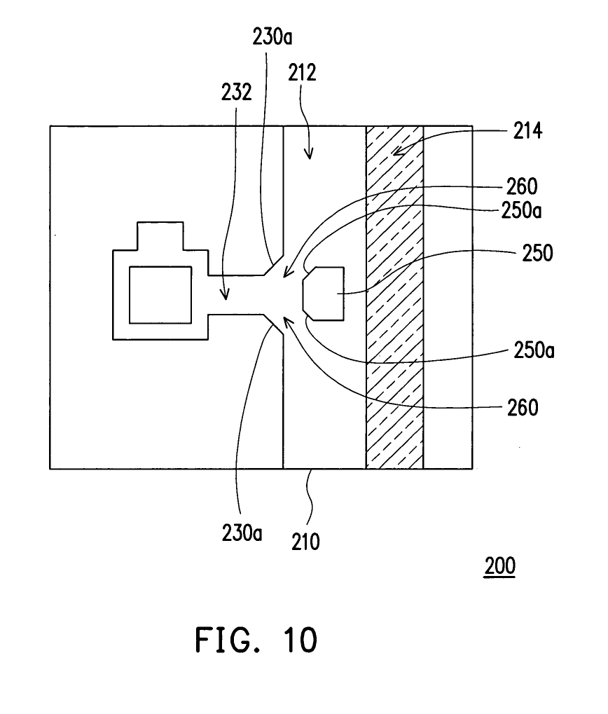

FIG. 9 is a perspective view of an inkjet print head according to another embodiment of the present invention. FIG. 10 is a top view of the inkjet print head in FIG. 9. The inkjet print head 200 has a structure almost identical to the aforementioned embodiments. One major difference is that the chamber layer 230 further comprises a pair of first ink-channeling surfaces 230a with each first ink-channeling surfaces 230a being formed on one side of the first ink channel 232. In addition, at least an island 250 is also placed on the upper surface 212 of the ink chip 210. The island 250 can be circular, elliptical or polygonal, for example. Preferably, the island 250 has a pair of second ink-channeling surfaces 250a and the island 250 is positioned between the first ink channel 232 and the ink slot 214. The first ink-channeling surfaces 230a and the second ink-channeling surfaces 250a together form a pair of second ink channels 260 that join with the first ink channel 232. In this embodiment, the first ink-channeling surfaces 230a and their corresponding second ink-channeling surfaces 250a are parallel to each other (however, it is not necessary to be parallel in other embodiments). By placing an island 250 to form a pair of second ink channels 260 joining with the first ink channel 232, ink refilling frequency and jetting stability during a printing operation is improved. It should be noted that the position of the island 250 is not limited to a location outside the first ink channel 232. In fact, a portion of the island 250 or the entire island 250 may lie within the first ink channel 232. In other words, one of the embodiments of this invention includes at least an island 250 positioned outside the first ink channel 232 or a portion of the island 250 or the entire island 250 positioned within the first ink channel 232.

It should be noted that the nozzle plate and the chamber layer in the aforementioned embodiments are two independent components. The nozzle plate is an electroforming nickel plate and the chamber layer is a dry film, for example. The nozzles are formed through the nozzle plate while the ink chambers and ink channels are formed on the chamber layer, which are fabricated separately.

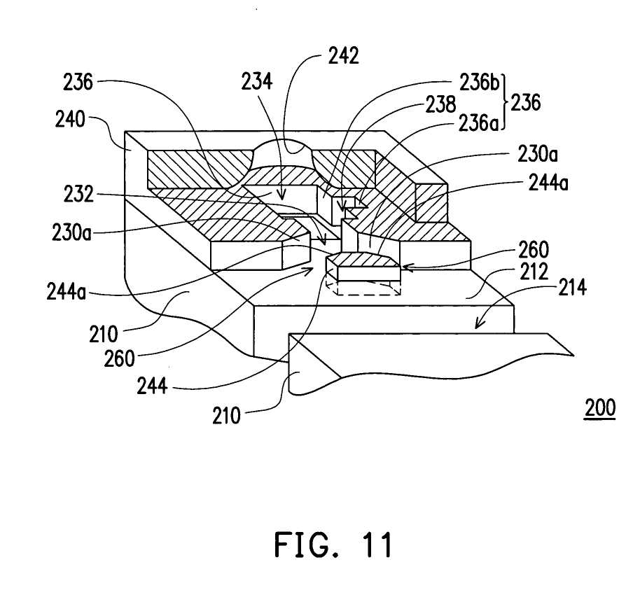

However, this invention does not limit the design to separately fabricate the nozzle plate and the chamber layer then attach the nozzle plate to the chamber layer. FIG. 11 is a perspective view of an inkjet print head according to yet another embodiment of the present invention. As shown in FIG. 11, the inkjet print head 200 has a structure similar to the aforementioned embodiments. One major aspect of this embodiment is that the nozzle plate 240 is directly attached to the surface 212 of the ink chip 210. Furthermore, the first ink channel 232, the ink chamber 234, the collecting rooms 238 and the nozzles 242 are fabricated on the nozzle plate 240. Thus, ink can flow from the ink slot 214 of the ink chip 210 to the ink chamber 234 via the first ink channel 232 and is ejected from the nozzle 242 as an ink droplet.

When the first ink channel 232, the ink chamber 234, the collecting rooms 238 and the nozzles 242 are directly fabricated on the nozzle plate 240, the nozzle plate 240 is preferably fabricated using a high molecular weight polymeric compound. The high molecular weight polymeric compound can be selected from a group of materials consisting of polyimide polymers, polyester polymers, polycarbonate polymers or a homopolymers, copolymers, terpolymers of the above polymers or a blend of two or more of the aforementioned polyimide polymers, polyester polymers and polycarbonate polymers. A detailed description related to the polymeric nozzle plate can be referred to U.S. Pat. No. 6,283,584.

As shown in FIG. 11, the nozzle plate 240 further comprises at least a projection 244 protruded from the bottom surface of the nozzle plate 240 between the first ink channel 232 and the ink slot 214. Moreover, the projection 244 is in contact with or at a distance away from the upper surface 212 of the ink chip 210. In other words, the projection 244 is part of the nozzle plate 240 and protrudes from its bottom surface. Similarly, the projection 244 is located between the first ink channel 232 and the ink slot 214 means that the projection 244 is not limited to a position outside the first ink channel 232. A portion of the projection 244 or the entire projection 244 may be positioned within the first ink channel 232.

In addition, the projection 244 of the nozzle plate 240 also has a pair of second ink-channeling surfaces 244a. The first ink-channeling surfaces 230a being formed on sides of the first ink channel 232 and the second ink-channeling surfaces 244a together form a pair of second ink channels 260 that join to the first ink channel 232. In other words, the projection 244 on the nozzle plate 240 is almost equivalent to the island 250 in the aforementioned embodiment. Consequently, by the projection 244 on the nozzle plate 240, a pair of second ink channels 260 joining with the first ink channel 232 is capable of improving the ink refilling frequency and jetting stability during a printing operation is produced.

In summary, at least one of the chamber walls of the ink chamber according to the present invention has a distance offset between two areas formed on the chamber wall so that at least one collecting room is formed. Consequently, any air bubbles and/or impurities within ink or generated after an ink-jetting operation is collected inside the collecting room. With this design, the inkjet print head can have a higher jetting stability and a longer operating life. Furthermore, by forming an island before the ink channel (or within the ink channel) that leads to the ink chamber, two ink channels capable of increasing the ink refilling frequency and ink drop volume of the ink jet printer are formed.

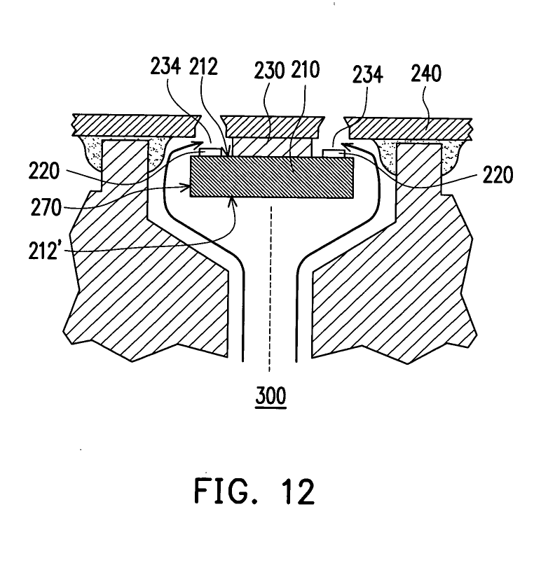

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. For example, the design of the collecting room according to the invention in the aforementioned embodiments is illustrative by the center feeding chip. This design can also be applied on the edge feeding chip as that disclosed in U.S. Pat. No. 5,278,584. In such a design, the chip 210 has a top surface 212 and an opposing bottom surface 212′ (FIG. 12), and has a first outer edge 270 along a periphery of the chip 210. The chip 210 has at least an ink channel and at least an ink chamber 234. The ink channel connects the ink reservoir 300 to the ink chamber 234 to allow ink to flow from the ink reservoir 300, around the first outer edge 270 of the chip, and to the ink chamber 234 (this flooding path acts as a second ink flooding channel like the ink slot in the center feeding chip). At least one chamber wall of the ink chamber 234 has a distance offset between two areas formed on the chamber wall so that at least one collecting room is formed, which is the same as the in the aforementioned embodiments.

The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An inkjet print head, comprising:
an ink chip, having a surface and at least an ink slot formed through the ink chip;
at least a heater, formed on the surface of the ink chip;
a chamber layer, having at least a first ink channel and at least an ink chamber, formed on the surface of the ink chip, the ink chamber exposing the heater, the ink chamber connecting to the ink slot by the first ink channel, the ink chamber having a plurality of chamber walls with at least one of the chamber walls having a first area and a second area, the first area corresponding with the heater and an offset distance being between the first area and the second area; and
a nozzle plate, having at least a nozzle formed therein, being positioned on the chamber layer of the chip so that the nozzle is above the heater.

2. The inkjet print head of claim 1, wherein the offset distance from the first area of the chamber wall to the heater is between about 1 μm to about 38 μm.

3. The inkjet print head of claim 1, wherein the print head further comprises at least an island formed on the surface of the ink chip between the first ink channel and the ink slot.

4. The inkjet print head of claim 3, wherein the chamber layer further comprises a pair of first ink-channeling surfaces with each first ink-channeling surface located on each side of the first ink channel.

5. The inkjet print head of claim 4, wherein the island has a pair of second ink-channeling surfaces such that the first ink-channeling surfaces and the second ink-channeling surfaces together form a pair of second ink channels that joint with the first ink channel.

6. The inkjet print head of claim 5, wherein each first ink-channeling surface and its corresponding second ink-channeling surface are parallel to each other.

7. The inkjet print head of claim 1, wherein the nozzle is not over the first area of the chamber wall.

8. An inkjet print head, comprising:
an ink chip, having a surface and at least an ink slot formed through the ink chip;
at least a heater, formed on the surface of the ink chip;
a chamber layer, having at least a first ink channel and at least an ink chamber, formed on the surface of the ink chip, the ink chamber exposing the heater, the ink chamber connecting to the ink slot by the first ink channel, the ink chamber having a plurality of chamber walls and at least one of the chamber walls caves in to form at least a collecting room; and
a nozzle plate, having at least a nozzle that is formed through the nozzle plate positioned on the chamber layer, wherein the nozzle is above the heater.

9. The inkjet print head of claim 8, wherein the print head further comprises an island formed on the surface of the ink chip between the first ink channel and the ink slot.

10. The inkjet print head of claim 9, wherein the chamber layer further comprises a pair of first ink-channeling surfaces with each first ink-channeling surface being positioned on each side of the first ink channel.

11. The inkjet print head of claim 10, wherein the island has a pair of second ink-channeling surfaces such that the first ink-channeling surfaces and the second ink-channeling surfaces together form a pair of second ink channels that join with the first ink channel.

12. The inkjet print head of claim 11, wherein each first ink-channeling surface and its corresponding second ink-channeling surface are parallel to each other.

13. The inkjet print head of claim 8, wherein the nozzle is not positioned directly above the collecting room.

14. An inkjet print head, comprising:
an ink chip, having a surface and at least an ink slot formed through the ink chip;
at least a heater, formed on the surface of the ink chip; and
a nozzle plate, having at least a first ink channel, at least an ink chamber and at least a nozzle, positioned on the surface of the ink chip, the ink chamber exposing the heater and the ink chamber connecting to the ink slot by the first ink channel, the ink chamber having a plurality of chamber walls and at least one of the chamber walls having a first area and a second area, the first area corresponding to the heater and an offset distance being between the first area and the second area, and the nozzle being above the heater and corresponding to the ink chamber.

15. The inkjet print head of claim 14, wherein the offset distance from the first area of the chamber wall to the heater is between about 1 μm to about 38 μm.

16. The inkjet print head of claim 14, wherein the nozzle plate further comprises a projection protruding from the bottom surface of the nozzle plate between the first ink channel and the ink slot.

17. The inkjet print head of claim 16, wherein the nozzle plate further comprises a pair of first ink-channeling surfaces on each side of the first ink channel, and the projection of the nozzle plate further comprises a pair of second ink-channeling surfaces such that the first ink-channel surfaces and the second ink-channeling surfaces together form a pair of second ink channels that join to the first ink channel.

18. The inkjet print head of claim 17, wherein each first ink-channeling surface and its corresponding second ink-channeling surface are parallel to each other.

19. The inkjet print head of claim 14, wherein the nozzle is not above the first area of the chamber wall.

20. An inkjet print head, comprising:
an ink chip with a surface and at least an ink slot formed through the ink chip;
at least a heater, formed on the surface of the ink chip;
a nozzle plate, having at least a first ink channel, at least an ink chamber and at least a nozzle, positioned on the surface of the ink chip, the ink chamber exposing the heater and the ink chamber connecting to the ink slot by the first ink channel, the ink chamber having a plurality of chamber walls, at least one of the chamber walls caving in to form at least a collecting room, and the nozzle being above the heater and corresponding to the ink chamber.

21. The inkjet print head of claim 20, wherein the nozzle plate further comprises a projection protruding from the bottom surface of the nozzle plate between the first ink channel and the ink slot.

22. The inkjet print head of claim 20, wherein the nozzle plate further comprises a pair of first ink-channeling surfaces on each side of the first ink channel and the projection of the nozzle plate further comprises a pair of second ink-channeling surfaces such that the first ink-channel surfaces and the second ink-channeling surfaces together form a pair of second ink channels that join to the first ink channel.

23. The inkjet print head of claim 22, wherein each first ink-channeling surface and its corresponding second ink-channeling surface are parallel to each other.

24. The inkjet print head of claim 20, wherein the nozzle is not above the collecting room.

25. An inkjet print head, comprising:
an ink chip, having a top surface and an opposing bottom surface, and having a first outer edge along a periphery of the chip;
at least a heater, formed on the top surface of ink chip;
a chamber layer, having at least a first ink channel and at least an ink chamber, formed on the top surface of the ink chip, the ink chamber exposing the heater, the ink chamber connecting with an ink reservoir by the first ink channel, the first ink channel allowing ink to flow from the ink reservoir, around the first outer edge of the chip, and to the ink chamber, the ink chamber having a plurality of chamber walls with at least one of the chamber walls having a first area and a second area, the first area corresponding with the heater and an offset distance being between the first area and the second area; and
a nozzle plate, having at least a nozzle formed therein, being positioned on the chamber layer of the chip so that the nozzle is above the heater.

26. An inkjet print head, comprising:
an ink chip, having a top surface and an opposing bottom surface, and having a first outer edge along a periphery of the chip;
at least a heater, formed on the top surface of ink chip; and
a nozzle plate, having at least a first ink channel, at least an ink chamber and at least a nozzle, positioned on the surface of the ink chip, the ink chamber exposing the heater and the ink chamber connecting with an ink reservoir by the first ink channel, the first ink channel allowing ink to flow from the ink reservoir, around the first outer edge of the chip, and to the ink chamber, the ink chamber having a plurality of chamber walls with at least one of the chamber walls having a first area and a second area, the first area corresponding with the heater and an offset distance being between the first area and the second area to form at least one collecting room, the nozzle being above the heater and corresponding to the ink chamber.
